(19) United States
(12) Patent Application Publication
(10) Pub. No.: US 2010/0094536 A1
(43) Pub. Date: Apr. 15, 2010

(54) FRIEND-FINDING MOBILE DEVICE

(75) Inventors: Choy Wai Lee, Olathe, KS (US); Nicholas S. Grimsley, Overland Park, KS (US); Nicolas S. Kral, Lawrence, KS (US); Timothy J. Barry, Olathe, KS (US); Barton D. Stanley, Overland Park, KS (US); Pendra C. Peh, Overland Park, KS (US); Alfredo E. Gunara, Overland Park, KS (US); Qiang Zeng, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., Camana Bay (KY)

(21) Appl. No.: 12/469,136

(22) Filed: May 20, 2009

Related U.S. Application Data
(63) Continuation of application No. 11/215,868, filed on Aug. 31, 2005.

(51) Int. Cl. G01C 21/00; G01S 19/42; G06F 3/048; H04W 4/02; G06F 15/16; G06F 17/30

(52) U.S. Cl. 701/201; 342/357.09; 715/810; 455/456.1; 709/217; 707/705; 707/E17.107

(57) ABSTRACT

An off-board navigation application is provided that is configured to be stored in memory on a wireless portable device. The application comprises a menu hierarchy including a series of pages to be presented on a screen of the device. The pages include a category page having a list of categories. The categories each are associated with points of interest (POIs). The menu hierarchy includes an address page presenting address information related to a selected point of interest (POI). The address page includes a function option that directs the portable device to transmit wirelessly a navigation information request to a remote server. The menu hierarchy includes a navigation page configured to present navigation information that is received wirelessly by the portable device from the remote server in response to the navigation information request. Optionally, the application may further comprise a sub-category page presenting a list of POI names, wherein the address page presents address information in response to the selected POI. The function option may represent a GO option such that, when the GO option is selected, the application directs the portable device to transmit a navigation information request to the remote server. The navigation information request instructs the remote server to perform a route calculation from a present location of the portable device to the selected POI.

### RELATED APPLICATION

The present application is a continuation of, and claims priority benefit to, co-pending and commonly assigned U.S. patent application entitled “METHOD AND SYSTEM FOR OFF-BOARD NAVIGATION WITH A PORTABLE DEVICE,” application Ser. No. 11/215,868, filed Aug. 31, 2005, which is incorporated herein by reference.

### BACKGROUND

The present invention is generally related to methods and apparatus for off-board navigation, and more particularly, to navigation utilizing a portable device and remote network server.

Today, systems exist that offer real-time interactive distributed navigation through the use of a wireless device. The wireless device communicates over a wireless carrier to a remote server that performs various navigation related functions and returns navigation information to the wireless device for review by an operator.

However, distributed navigation systems have a somewhat limited feature set and offer limited functions. Conventional distributed navigation systems have a user interface that is awkward and less than user friendly. Also, the amount of navigation information related to a particular operation, often may be quite large. As the amount of navigation information increases, it exceeds the storage capacity of the wireless device and introduces an additional delay during operation while large amounts of navigation information are being conveyed to the wireless device.

A need remains for an improved distributed navigation system. It is an object of certain embodiments to address the above and other needs of distributed wireless systems and methods.

### BRIEF DESCRIPTION

An off-board navigation application is provided that is configured to be stored in memory on a wireless portable device. The application comprises a menu hierarchy including a series of pages to be presented on a screen of the device. The pages include a category page having a list of categories. The categories each are associated with points of interest (POIs). The menu hierarchy includes an address page presenting address information related to a selected point of interest (POI). The address page includes a function option that directs the portable device to transmit wirelessly a navigation information request to a remote server. The menu hierarchy includes a navigation page configured to present navigation information that is received wirelessly by the portable device from the remote server in response to the navigation information request.

Optionally, the application may further comprise a sub-category page presenting a list of POI names, wherein the address page presents address information in response to the selected POI. The function option may represent a GO option such that, when the GO option is selected, the application directs the portable device to transmit a navigation information request to the remote server. The navigation information request instructs the remote server to perform a route calculation from a present location of the portable device to the selected POI. Optionally, the function option may represent a SAVE option such that, when the SAVE option is selected, the application directs the portable device to transmit a waypoint management instruction to the remote server. The waypoint management instruction directs the remote server to save the selected POI as a waypoint associated with an individual user. Optionally, the function option represents a NEARBY option such that, when the NEARBY option is selected the application directs the portable device to transmit a navigation information request to the remote server. The navigation information request instructs the remote server to return a NEARBY category list of categories for destination points of interest that are near the selected POI.

In accordance with an alternative embodiment, a portable navigation device is provided that includes a wireless antenna, transmitter and receiver for communicating over a wireless network with a navigation enabled remote server. The device further includes a GPS antenna and receiver for receiving GPS signals from GPS satellites. A processor controls communication over the wireless network and processes the GPS signals. Memory is provided that stores an off-board navigation application. The application comprises a menu hierarchy including a series of pages to be presented on a screen of the device. The pages include a category page having a list of categories. The categories each are associated with points of interest (POIs). The menu hierarchy includes an address page presenting address information related to a selected point of interest (POI). The address page includes a function option that directs the portable device to transmit wirelessly a navigation information request to a remote server. The menu hierarchy includes a navigation page configured to present navigation information that is received wirelessly by the portable device from the remote server in response to the navigation information request.

In accordance with an alternative embodiment, the portable device includes a screen and cache. The screen presents a series of pages during operation of a navigation application. The pages includes a map page presenting a roadway network surrounding at least one of a present location of the device and a selected point of interest. The map page includes ZOOM options selectable by the user to select a level of detail displayed for the roadway network. The cache stores a portion of the map data having a predetermined intermediate level of map detail. The processor obtains map data from the cache when a selected ZOOM option corresponds to a level of detail stored in the cache. The processor obtains, over the wireless bidirectional link with the remote server, additional map data win the selected ZOOM option exceeds a level of detail stored in the cache.

In accordance with an alternative embodiment, the portable device includes a keypad and screen. The keypad has a series of keys for entering alphanumeric information, where each key on the keypad is associated with a corresponding alphanumeric character list including at least one letter and at least one numbers. The screen presents the alphanumeric information and, as an operator repeatedly presses an individual key, the processor sequences through the corresponding alphanumeric character list until a desired character is entered. The processor monitors each entered character and determines whether the entered character represents a letter or a number. The processor sets a start mode to one of an alphabetic start mode and a numeric start mode based on a prior entered character. The processor begins each sequence through a corresponding alphanumeric character list with a letter when the alphabetic start mode is set.

### BRIEF DESCRIPTION OF THE DRAWINGS

FIG. 1 illustrates a pictorial representation of a global positioning system (GPS) utilized with an embodiment of the present invention.

FIG. 2 illustrates a blocked diagram of an off-board distributed navigation system formed in accordance with an embodiment of the present invention.

FIG. 3 illustrates an exemplary portable wireless device operated in accordance with an embodiment of the present invention.

FIG. 4 illustrates a block diagram of the electronic components of a portable device formed in accordance with an embodiment of the present invention.

FIG. 5 illustrates a point of interest menu structure provided in accordance with an embodiment of the present invention.

FIG. 6 illustrates an address search menu structure provided in an accordance with an embodiment of the present invention.

FIG. 7 illustrates a find name menu structure provided in accordance with an embodiment of the present invention.

FIG. 8 illustrates a find near-by points of interest menu structure provided in accordance with an embodiment of the present invention.

FIG. 9 illustrates a save location menu structure provided in accordance with an embodiment of the present invention.

FIG. 10 illustrates a find location menu structure provided in accordance with an embodiment of the present invention.

FIG. 11 illustrates a find friend menu structure provided in accordance with an embodiment of the present invention.

FIG. 12 illustrates a find near-by points of interest menu structure provided in accordance with an embodiment of the present invention.

FIG. 13 illustrates a flow chart for managing a local queue of the most recent waypoints in accordance with an embodiment of the present invention.

FIG. 14 illustrates a format of a web page provided in accordance with an embodiment of the present invention.

FIG. 15 illustrates a user interface screen flow provided in accordance with an embodiment of the present invention.

FIG. 16 illustrates an alternative screen flow provided in accordance with an embodiment of the present invention.

FIG. 17 illustrates a flow chart of processing operations carried out to manage storage of map data in cache in accordance with an embodiment of the present invention.

FIG. 18 illustrates a flow chart of processing operations carried out to facilitate data entry at the keypad in accordance with an embodiment of the present invention.

### DETAILED DESCRIPTION

In the following detailed description, reference is made to the accompanying drawings which form a part hereof, and in which is shown, by way of illustration, specific embodiments in which the invention may be practiced. The embodiments are intended to describe aspects of the invention in sufficient detail to enable those skilled in the art to practice the invention. Other embodiments may be utilized and changes may be made without departing from the scope of the present invention. The following detailed description is, therefore, not to be taken in a limiting sense, and the scope of the present invention is defined only by the appended claims, along with the full scope of equivalents to which such claims are entitled.

The embodiments discussed hereafter are drawn to navigational systems and devices having navigation and, route calculation capabilities. One type of navigational system includes Global Positioning Systems (GPS). Such systems are known and have a variety of uses. In general, GPS is a satellite-based radio navigation system capable of determining continuous position, velocity, time, and in some instances direction information for an unlimited number of users. Formally known as NAVSTAR, the GPS incorporates a plurality of satellites which orbit the earth in extremely precise orbits. Based on these precise orbits, GPS satellites can relay their location to any number of receiving units.

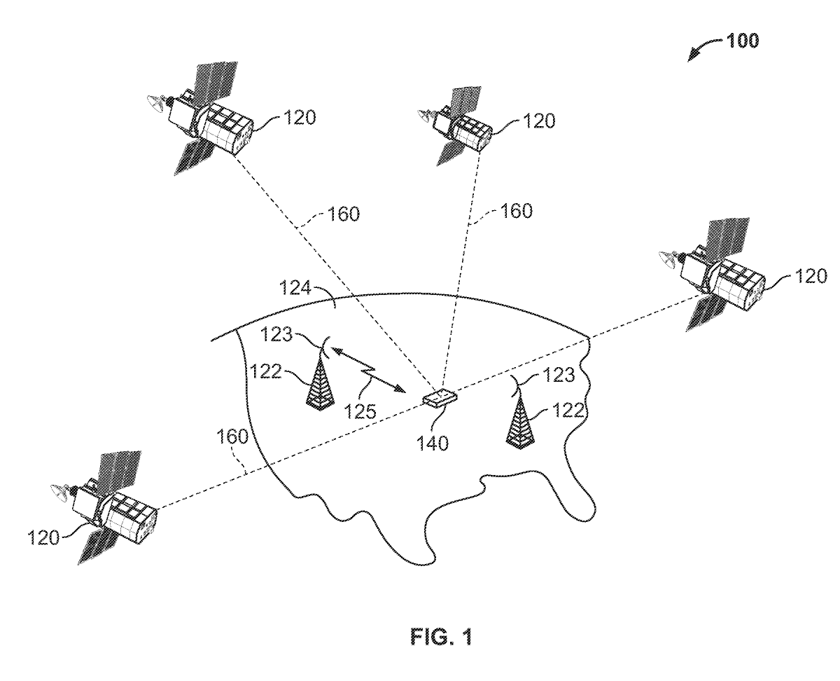

FIG. 1 is representative of a distributed off-board navigation network 100 that includes a plurality of satellites 120 arranged in orbit about the Earth 124. The orbit of each satellite 120 is not necessarily synchronous with the orbits of other satellites 120 and may be asynchronous. A GPS-enabled wireless device 140 is provided with a GPS receiver that scans radio frequencies for GPS signals 160 from the satellites 120. Upon receiving a radio signal from a GPS satellite 120, the device 140 determines the precise location of the satellite 120 via one of different conventional methods. The device 140 continues scanning for signals 160 until it has acquired at least three different satellite signals. Implementing geometric triangulation, the device 140 utilizes the three known satellite positions to determine the two-dimensional position of the device 140 relative to the satellites 120. Additionally, the device 140 may acquire a fourth satellite GPS signal 160 which will allow the device 140 to calculate the three-dimensional position of the device 140 by the same geometrical calculation. The positioning and velocity data can be updated in real time on a continuous basis by an unlimited number of users. The signals 160 are spread spectrum and continuously transmitted from each satellite 120 utilize a highly accurate frequency standard accomplished with an extremely accurate atomic clock. Each satellite 120, as part of its data signal transmission, transmits a data stream indicative of that particular satellite 120.

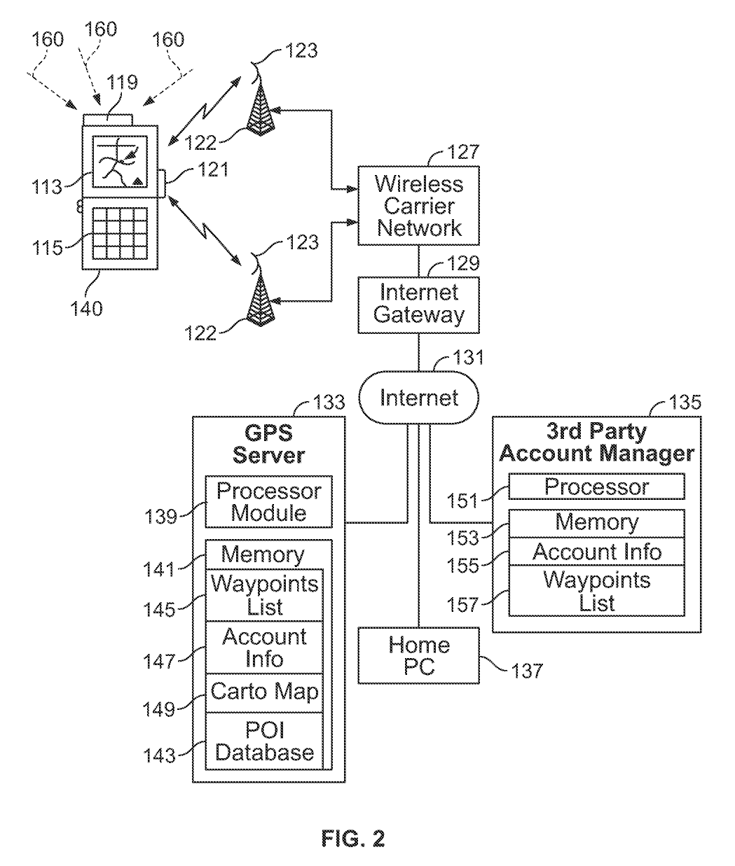

As shown in FIGS. 1 and 2, the device 140 also includes a wireless transmitter and receiver (transceiver) 121 that is configured to wirelessly communicate over bidirectional links 125 with towers 122. The device 140 includes a keypad 115 and a display 113. In FIG. 1, a series of towers 122 are provided that include transceivers 123 that transmit and receive over links 125 with the device 140. As shown in FIG. 2, the towers 122 are joined to one or more wireless carrier networks 127 that manage communications over the towers 122. The wireless carrier network 127 provides a link through an Internet gateway 129 to the Internet 131. A GPS server 133, a third-party account manager 135 and home PC 137 are examples of some of the types of devices joined to the Internet 131 and that may be utilized in connection with certain operations and functions described herein. The GPS server 133 may be managed by a GPS equipment provider (e.g., Garmin), while the third-party account manager may represent an Internet service provider (e.g. AOL, YAHOO and the like). One or both of the GPS server 133 and third-party account manager 135 maintain individual accounts for users that may include, among other things, stored lists of waypoints or points of interest, individualized categories, lists of points of interest organized by category and the like. The term “waypoint” shall be used to represent a “point of interest” when the POI is identified by a particular user as being of interest and saved in the users waypoint list.

The GPS server 133 includes a processor module 139 that manages individual user accounts, as well as performs navigation and routing operations based on requests from individual devices 140. The GPS server 133 also includes memory 141. The memory 141 stores, among other things, a cartographic map 149, a point of interest (POI) database 143, waypoint lists 145 and account information 147. The account information individually identifies each registered user. Each user account includes or has a unique link to a waypoint list 145 uniquely associated with an individual user. Each waypoint list includes a list of points of interest that have been identified by the user and saved in the user's individual account. The waypoint lists may be organized by category or alphabetically or both.

The third party account manager 139 includes a processor module 151 and memory 153. The memory 153 stores, among other things, individual account information 155 and waypoint lists 157 uniquely associated with each user. The waypoint lists 157 may be uniquely associated with each user and/or may be based on general categories.

In accordance with one off-board navigation process, the device 140 receives, at GPS antennae 119, GPS signals 160 from various satellites 120 and, based thereon, calculates the position of the device 140. The device 140 stores a navigation application that includes a navigation menu hierarchy or screen flow of screens, options, icons and text entry boxes. The hierarch defines a screen flow through which the device 140 sequences to complete various navigation-related operations. During menu-driven routing/mapping applications, the device 140 transmits its position information, a waypoint management instruction and/or a navigation information request over the wireless link 125 to a tower 122. The position information may simply include the satellite signals 160 received by the device 140 at a particular point in time. Alternatively, the device 140 may calculate a latitude and longitude coordinate combination representing the current position of the device 140, and transmit the latitude and longitude coordinate combination as the position information to the tower 122. The navigation information request may include a destination waypoint or point of interest and/or a request to calculate a route to the destination point of interest. Alternatively, the navigation information request may simply represent a request for a portion of the cartographic map for an area surrounding the device 140 and/or surrounding a point of interest. The navigation information request may also represent a selected item from an application menu (e.g. a selection of a category of POIs), text information or a list of potential matches. The navigation information request may also include a destination indicator identifying where the request should be routed by the wireless carrier network. Waypoint management instructions are utilized in connection with managing an individual user's account that is maintained by the GPS server 133 and/or a third party account manager 135. A waypoint management instruction may include information related to and/or identifying a particular point of interest, as well as a management instruction (e.g. rename, delete, copy, say, move, edit and the like).

The wireless carrier network 127 and Internet gateway 129 uniquely identify the device 140 and/or incoming navigation request, determine a destination corresponding to the GPS server 133 and/or the third-party account manager 135 and route the position information and navigation request to the corresponding destination. The destination may represent a statically or dynamically designated IP address and the like. The GPS server 133 and/or third-party account manager 135 store cartographic maps and have a large processing capability to perform computationally intensive navigation calculations. The GPS server 133 and/or third-party POIs account manager 135 receive the request, calculate or otherwise obtain the appropriate response, and convey reply navigation information over the Internet 131, Internet gateway 129, wireless carrier 127, and towers 122 to the device 140. The reply navigation information may include alphanumeric text (e.g., addresses, numbers, names, distance, directions), a route from the present location of the device 140 to a destination point of interest, a clipped portion of map data surrounding the device 140 or surrounding a point of interest and the like. The GPS server 133 performs navigation functions and transmits calculated results and reply navigation information (e.g. text, a route, roadway map data, etc.) wirelessly to the device 140, thereby enabling the device 140 to become a navigation device.

The GPS server 133 stores a cartographic or map database includes any number of locations and data indicative of thoroughfares of a plurality of types connecting certain ones of the locations. Different types of thoroughfares are contained in the data structure organized in a hierarchy of detail levels, or layers. The GPS server 133 utilizes a route calculation alGOrithm to find a path, or convergence, between any two locations in the data structure based on various criteria. For example, the criteria may include a number of jump segments requirement, a distance requirement, a minimum memory usage requirement, a maximum memory usage requirement, and the like. The criteria may be independently variable in order to tailor an aggressiveness with which the route calculation alGOrithm forces switching between different levels in the hierarchy of detail levels. Optionally, the hierarchy of detail levels may include a hierarchy of ever-decreasing detail levels such that a lowest level includes the greatest amount of detail. Any other suitable hierarchy of detail levels may be used.

In one embodiment, a type of thoroughfare in any given layer of the hierarchy of detail layers is determined by a traversability of the thoroughfare. For example, the traversability of the thoroughfare can be determined by the driveability of a road. Herein, the driveability of the road may be determined by the classification of the road, a speed classification of the road, a driving history on the road, and the like. However, the invention is not so limited and one of ordinary skill in the art will understand upon reading and comprehending this disclosure, that other criteria for determining the presence of a type of thoroughfare in any given layer of the hierarchy can be suited to the present invention.

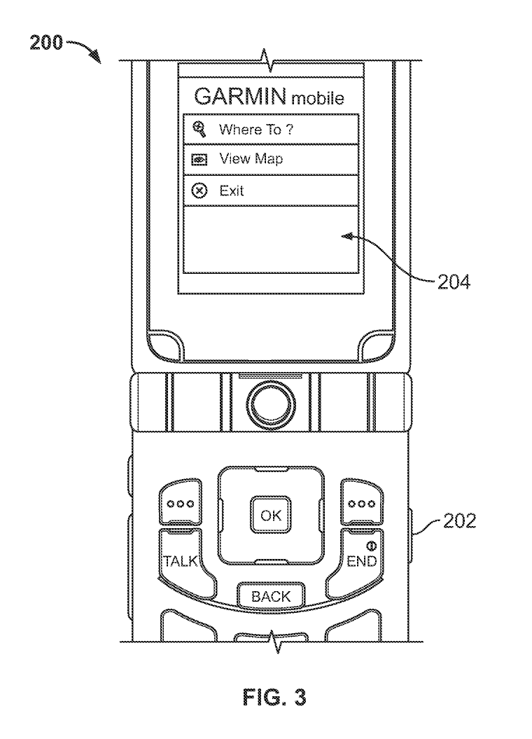

FIG. 3 illustrates a front plan view of a GPS equipped wireless device 200, such as a cell phone. The device 200 includes a user entry keypad 202 and a display 204. The device 200 includes a GPS antenna and GPS receiver that receives satellite signals from GPS satellites, and a wireless antenna and wireless receiver that bi-directionally communicate with a wireless network, such as a cellular telephone network. The display outputs various types of information, such as roadway maps, menus, alphanumeric text, graphics, video, still images, pictures, routing information and the like.

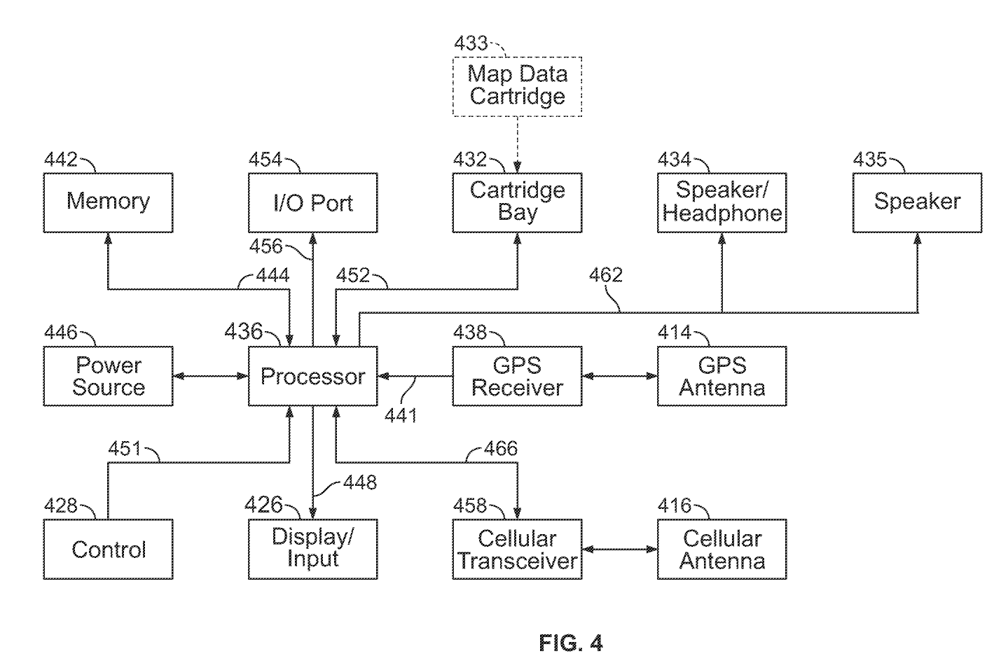

FIG. 4 illustrates a block diagram of one embodiment for the electronic components 400 within the device 140 or 200. The electronic components 400 includes a processor 436 which is connected to a GPS antenna 414 through GPS receiver 438 via line 441. The GPS antenna 414 is configured to receive GPS signals from satellites. The processor 436 interacts with an operating system (such as PalmOS; Pocket PC) that runs selected software depending on the intended use of the device 140 or 200. Processor 436 is coupled with memory 442 such as RAM or CACHE via line 444, and power source 446 for powering the electronic components of the device 140 or 200. The processor 436 calculates the present location (latitude, longitude and altitude) of the device 140 or 200 based on received GPS signals. The processor 436 operates a navigation application stored in memory 442 as explained below. The processor 436 communicates with display screen 426 via data line 448 to output the various types of information, such as roadway maps, menus, alphanumeric text, graphics, video, still images, pictures, routing information and the like. The display 440 is adapted to display all or part of the navigation information (e.g. roadway maps, addresses, names, phone numbers, real-time moving maps, simulated video advancement over a roadway network and the like) and menu structure or hierarchy (e.g. page layouts, page pixel formats, coloring, menu item names, forward and return links to other menu pages and the like).

The electronic components 400 further include other input sources that are connected to the processor 436. Control buttons 428 are connected to processor 436 via line 451. A map data cartridge 433 and/or a security card 431 may be inserted into cartridge bay 432 that is connected via line 452 to the processor 436. A conventional serial I/O port 454 is connected to the processor 436 via line 456. Cellular antenna 416 is connected to cellular transceiver 458, which is connected to the processor 436 via line 466. Processor 436 is connected to the speaker/headphone jack 434 via line 462. Line 462 is also connected to a speaker 435 for playing audio navigation information. For example, the speaker 435 may output turn-by-turn directions, words or phrases and the like. The device may also include an infrared port (not shown) coupled to the processor 436 that may be used to transmit information from one device to another.

The memory 442 may be configured to store a navigation menu hierarchy or structure utilized by the user in connection with creating navigation requests and reviewing received navigation information. The menu structure also facilitates saving and using commonly accessed or favorite waypoints or POIs. The memory 442 also is configured to temporarily store at least portions of map data received over the wireless link 125 (FIG. 1) in response to a navigation request. The map data includes cartographic mapping information associated with a roadway network. In operation, the processor 436 accesses the menu structure and map data in connection with navigation operations. Optionally, the menu structure and map data may be stored in entirely separate memories or sections of memory. For example, the map data may be stored in cache, while the menu structure is stored in a more stable permanent memory, such as RAM or ROM.

In general, the menu hierarchy includes an interlinked collection or series of screens or pages that are stored in memory 442. Each page comprises options, text entry boxes, graphics windows, video windows, etc. The options may represent a function options, that directs the device to perform a function, or an item data option that is selectable by the user. Certain function options will direct the device to transmit wirelessly a navigation information request to a remote server. The menu hierarchy includes navigation pages (e.g. map pages, routing pages and the like) that are configured to present navigation information that is received wirelessly by the device from the remote server in response to the navigation information request. Examples of function options include GO, SAVE, NEARBY, VIEW MAP, CALL and the like.

When the GO option is selected, the application directs the portable device to transmit a navigation information request to the remote server 133. The navigation information request instructs the remote server 133 to perform a route calculation from a present location of the device to the selected POI. When the SAVE option is selected, the application directs the portable device to transmit a waypoint management instruction to the remote server 133. The waypoint management instruction directs the remote server 133 to save the selected POI as a waypoint in a waypoint list 145 associated with an individual user account 147. When a NEARBY option is selected, the application directs the portable device to transmit a navigation information request to the remote server 133. The navigation information request instructs the remote server 133 to return a NEARBY category list of categories for destination POIs that are near the selected POI. When the device represents a cellular phone and the CALL option is selected, the cellular phone automatically initiates a call to the selected POI. When the VIEW MAP option is selected, a map page is presented on the screen of the device. The map paging includes a roadway network surrounding the selected POI.

The GPS server 133 stores a point of interest relational database and a waypoint list of POIs of interest to the user. The POIs and waypoints are designated by name, address, latitude, longitude and categories. The GPS server 133 accesses and modifies the waypoint database 145 based on function and data options.

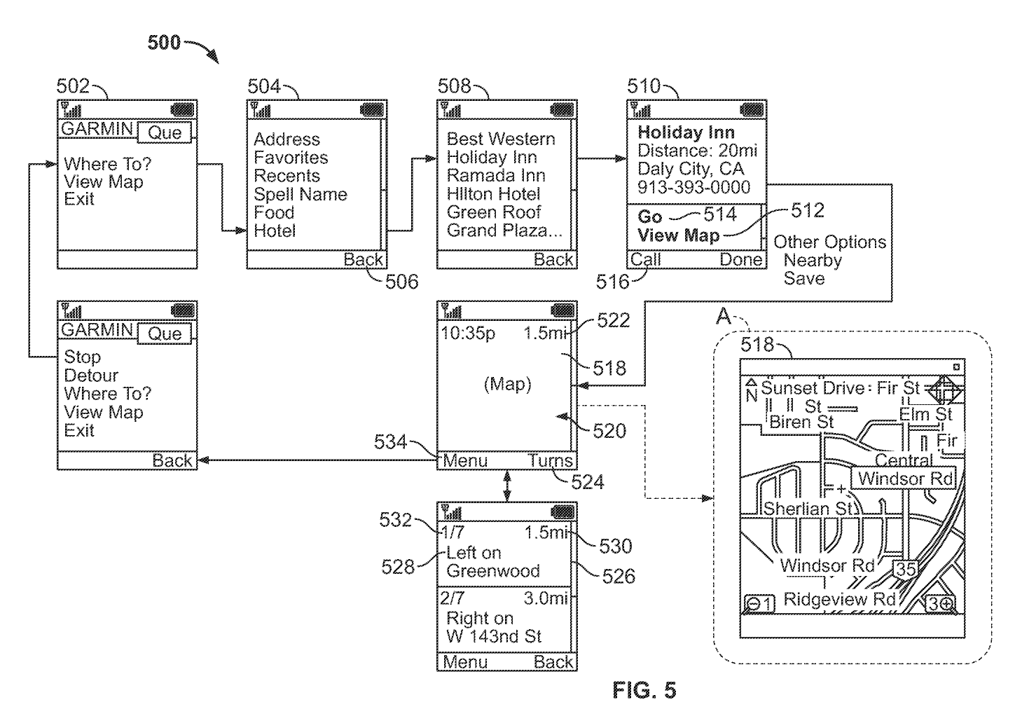

FIG. 5 illustrates a portion of a find POI screen flow or menu hierarchy 500 associated with finding a POI. A main menu page 502 allows the user to choose a “where to” function, a “view map” function, or an “exit” function. When the “where to” function is selected, a category screen or page 504 is obtained from memory 442 and displayed to allow the user to enter a particular “address”, GO to the user's individualized “favorites” list, view the most “recent” points of interest, “spell the name” of a particular point of interest, or select points of interest based on categories (e.g. food, hotel, transportation, commerce, business, medical and the like). A back icon or option 506 is provided to permit the user to move back to the prior main menu page 502. When the “hotel” category is selected from category page 504, a sub-category listing page 508 is presented with various hotels. The hotel list may be ordered alphabetically, based on individual user criteria, or based on the nearest hotels to the user's present location. Once a particular hotel is selected, POI address page 510 is presented with the name and address of the hotel, distance to the hotel, direction to the hotel, phone number and the like.

A “view map” option 512 and a GO option 514 are offered on the POI address page 510. When the “view map” option 512 is selected, the device 140, 200 wirelessly transmits a navigation request to the GPS server 133 to obtain roadway map data surrounding the point of interest. The roadway map data is displayed on the display 113, 204 of the device 140, 200. When the GO option 514 is selected, the device transits a navigation request to the GPS server 133 to obtain a route from the device's present location to the point of interest. The address page 510 also offers a “call” option 516 that, when selected, instructs the device 140, 200 to automatically dial the telephone number of the point of interest over the wireless link 125 and wireless carrier network 127. Further options may include permitting the operator to save the point of interest as a “favorite” in the user's individual favorites account.

FIG. 5 also illustrates a map page 518 that is presented once the VIEW MAP option is selected and a corresponding portion of a cartographic map is returned from the GPS server 133 (FIG. 1). The map page 518 is shown enlarged in area A and includes the roadway network surrounding the POI, along with a direction indicator 520, and a distance to the POI 522. A MENU option 534 permits the user to return to the main menu that now includes additional options, namely a STOP option and a DETOUR option. A TURNS option 524 is provided on map page 518 to obtain turn-by-turn instructions from the present location of the device to the POI. When the TURNS option 524 is selected, a turn-by-turn page 526 is presented including turn-by-turn text 528, a distance between each turn 530, and a turn-count indicator 532 identifying the total number of turns to the destination and the number of the present turn within the total number of turns (e.g. 1 of 7, 6 of 7, etc.). The user may manually scroll through the turn-by-turn text 528 with arrow keys on the keyboard. Optionally, the device may automatically scroll through the turn-by-turn text 528 as the device progresses along the route.

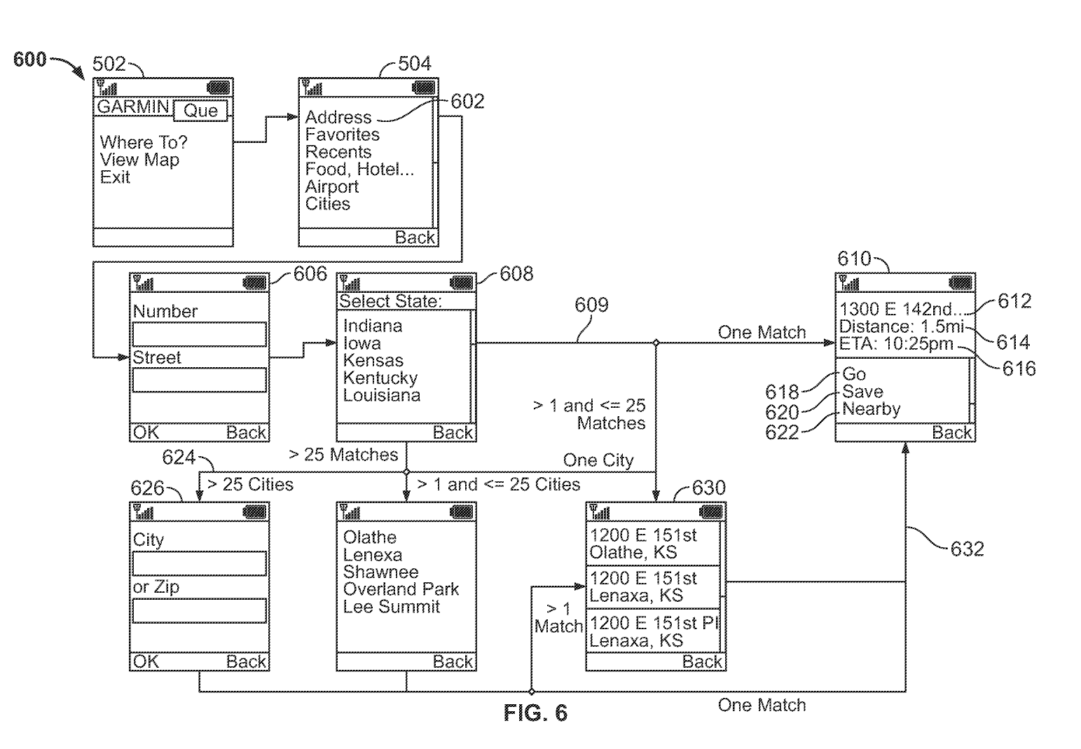

FIG. 6 illustrates an address search screen flow or menu hierarchy 600 that beginning at the main menu 502 and the category menu 504. When the address option 602 is selected from the category menu 504, an address data entry page 606 is presented. Once the user enters the address, a state listing page 608 is presented. Once the address and state are entered, the device transmits a navigation request, including the POI address and state, to the GPS server 133. Each navigation request may also include a screen flow indicator identifying the present point within the navigation screen flow or hierarchy, for example, that the user is attempting to locate an address. The GPS server 133 may return reply navigation information for one or more matches. When a single match exists, flow passes along line 609 to an address page 610.

Returning to the state listing page 608, when the GPS server 133 returns more than 25 matching cities, flow passes along line 624 to a city and ZIP code data entry page 626. The GPS server 133 may convey, in the reply navigation information to the device complete address information for all of the potential matches. Alternatively, the GPS server 133 may only return in the reply navigation information a list of cities from which the user chooses. After the user enters the city and ZIP code of the POI, the device transmits the city and zip code and the GPS server 133 returns the reply navigation information for one or more matches.

At the state listing page 608, when the GPS server 133 returns more than 1 and fewer than 25 matching cities, the list of cities 628 is displayed for the user to choose between. Next flow passes to page 630 where a list of potential matching addresses is shown. Once an address is selected from page 630, flow passes along line 632 to address page 610. The address page 610 presents the individual POI address 612, a distance to the POI 614 and an estimated time of arrival (ETA) 616. The ETA 616 is calculated from the present time based upon known travel patterns and route information associated with the roadway network between the device's present location and the POI. The address page 610 also offers a GO option 618, a SAVE option 620 and a NEARBY option 622. When the GO option 618 is selected, the device transmits a navigation information request to the GPS server 133, requesting that a route calculation be performed to identify a route between the present location of the device and the selected POI. When the SAVE option 620 is selected, the device transmits a waypoint management instruction to the GPS server 133 and/or third-party account manager 135 instructing that the selected POI be saved as a waypoint in the individual users account. When the NEARBY option is selected, the device transmits a navigation information request to the GPS server 133 requesting map data for a roadway network surrounding the selected POI.

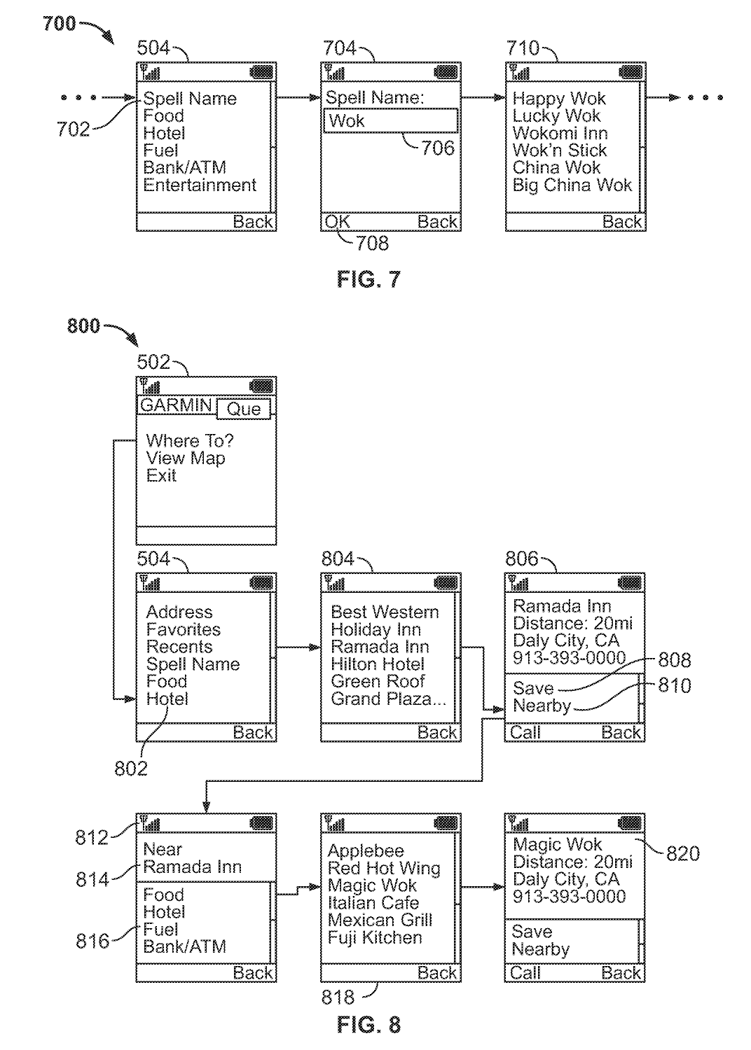

FIG. 7 illustrates a menu hierarchy 700 for locating a particular point of interest by spelling its name. Beginning at the category page 504, the SPELL NAME option 702 is selected. A spell name page 704 is presented with a text box 706 in which the user enters (via the keypad) all or part of the name of a point of interest. Once the name is entered in text box 706, the OK option 708 is selected. In accordance with one option, the device may already store in its internal memory 442 (FIG. 4) a list of points of interest, from which the processor 436 identifies matching points of interest. A name list page 710 presents a potential matching points of interest. When the device does not already include a list of potential points of interest in memory 442, upon entry of the name in text box 706, the device constructs a navigation request that is transmitted over the wireless link 125 (FIGS. 1 and 2) and routed to the GPS server 133. The GPS server 133 accesses the POI database 143 and returns a list of names matching the potential point of interest. The list of potential matches are returned as reply navigation information and presented on the page 710. The list of name on page 710 may be too long to all be displayed at once. The arrow keys on the keypad are used to scroll upward and downward through the list of names on page 710. Once a matching name is selected from page 710, an address page is presented (similar to the address pages 510 in FIGS. 5 and 610 in FIG. 6).

FIG. 8 illustrates a menu hierarchy 800 for performing a FIND NEARBY POI application. The user passes through the pages illustrated in FIG. 8 in order to construct a navigation request to identify a NEARBY point of interest and, in response, the GPS server 133 returns the reply navigation information related to the NEARBY point of interest. FIG. 8 flow begins at the main menu 502, from which the WHERE TO option is selected. The category page 504 is then presented and the hotel category 802 is selected. A hotel list page 804 is presented including a list of hotels that are ordered based upon the distance from each hotel to the device's present location. In the example of FIG. 8, a Best Western is the closest hotel, followed by a Holiday Inn, then a Ramada Inn, etc. If a particular hotel offers additional attributes that others do not offer, including but not limited to special discounts, special services, or users' reviews information; it will be displayed differently, either by use of different color, or graphical icons. When the Ramada Inn is selected, an address page 806 is displayed including the name and address of the hotel, the phone number and the distance to the hotel. The address page 806 also offers a SAVE option 808 and NEARBY option 810. The SAVE option 808 may be selected when the user desires to SAVE the hotel in the user's favorites list. The NEARBY option 810 may be selected when the user is interested in points of interest of other categories near the selected hotel. And additional option DETAILS may be available for hotels that have additional attributes as mentioned earlier. Users may select the DETAILS option to reveal more details about the selected hotel. Note that the feature to indicate additional attributes and display additional details is not limited to hotels, but any points of interest searchable by the application. Note that discounts offered by these points of interest are not redeemable by showing the wireless device, but by showing a separate identification medium recognized by the merchants, such as a credit-card-like discount card.

When the NEARBY option 810 is selected, flow passes to a near-by page 812 which shows the starting point (e.g., the Ramada Inn) 814 and a category list 816. The category list 816 includes category options (e.g., food, hotel, fuel, banks/ATM, etc.). When the user picks a category option, such as food, page 818 is displayed with a list of destinations within the selected category. In FIG. 8, the destination POIs represent restaurants located near the source POI, the Ramada Inn. When the user selects a destination POI from the page 818, address details are presented on page 820 for the selected destination, namely the name and address of the location, the distance to the destination and the telephone number of the destination. In one example, the distance shown in page 820 may represent the distance between source location 814 (namely the Ramada Inn) and the destination location (namely the Magic Wok). Optionally, the distance may be between the device's present location and the chosen destination location.

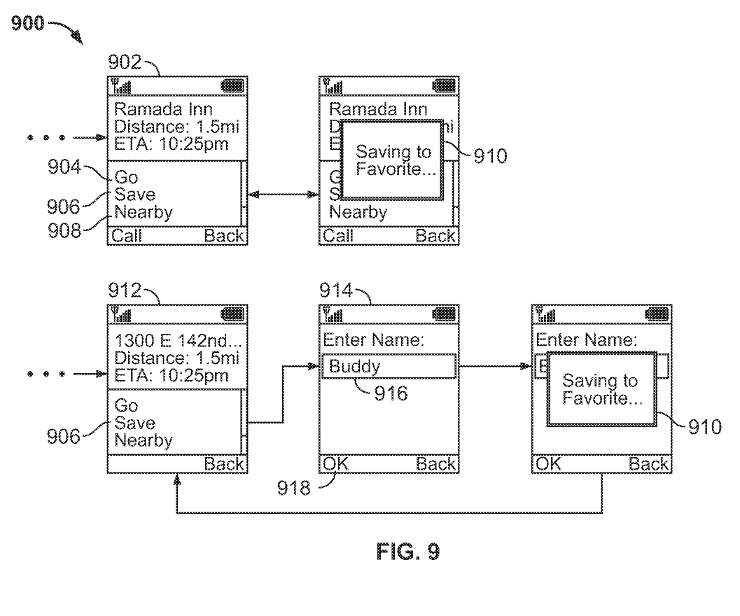

FIG. 9 illustrates a menu hierarchy 900 offered in connection with saving a particular location in a user's favorites. In FIG. 9, an address page 902 is associated with a particular destination. Page 902 offers the GO option 904, the SAVE option 906, and the “near-by” option 908. When the SAVE option 906 is selected, the device initiates a SAVE TO FAVORITES function shown by pop-up window 910. When the SAVE TO FAVORITES operation is carried out, the device constructs a navigation request that includes the address information for the selected point of interest (namely the Ramada Inn). The device then transmits the address information along with an instruction indicating that the user desires the point of interest to be saved to the user's favorites. Upon receiving the navigation request, the GPS server 133 and/or the third party account manager 135 records the address of the Ramada Inn in the favorites account for the user.

FIG. 9 illustrates an alternative screen flow carried out in connection with saving a point of interest to a user's favorites. Beginning at page 912, a particular address has been identified. When the user selects the SAVE option 906, a name page 914 is presented prompting the user to enter into text box 916 a name associated with the selected address. Once the name is entered and the OK option 918 is selected, the device initiates a SAVE operation as denoted by pop-up window 910. The SAVE TO FAVORITES option is carried out by the device transmitting, within a waypoint management instruction, the name and address to be saved in the user's favorites as a waypoint on the waypoint list. The GPS server 133 and/or third party account manager 135 save the address and name entered by the user within the user's favorites account on the user's individual waypoint list.

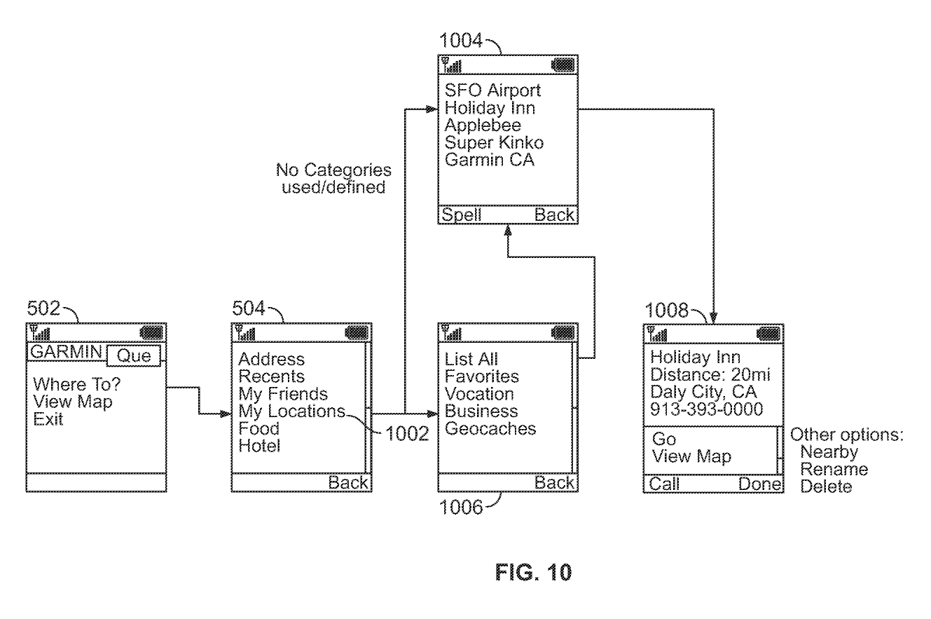

FIG. 10 illustrates a menu hierarchy presented in connection with finding a particular location based on the user's individual list of waypoints or points of interest. Beginning at the main menu 502, flow passes to the category menu 504, at which the “my locations” option 1002 is selected. Two page options are then available, depending upon the structure of the user's list of favorites. When the user has a single list of favorites that are not organized into sub-categories, flow passes to page 1004 in which each of the user's individual favorites are shown. Alternatively, when the user's favorites are organized into sub-categories, page 1006 is presented listing each of the sub-categories (e.g., list all, favorites, vacation, business, geo caches, etc.). In the example of FIG. 10, when the user selects the business option from page 1106, flow passes to page 1004 which shows the names of businesses saved within the user's individual location account. From page 1004, when an individual destination is selected, flow passes to the address page 1008.

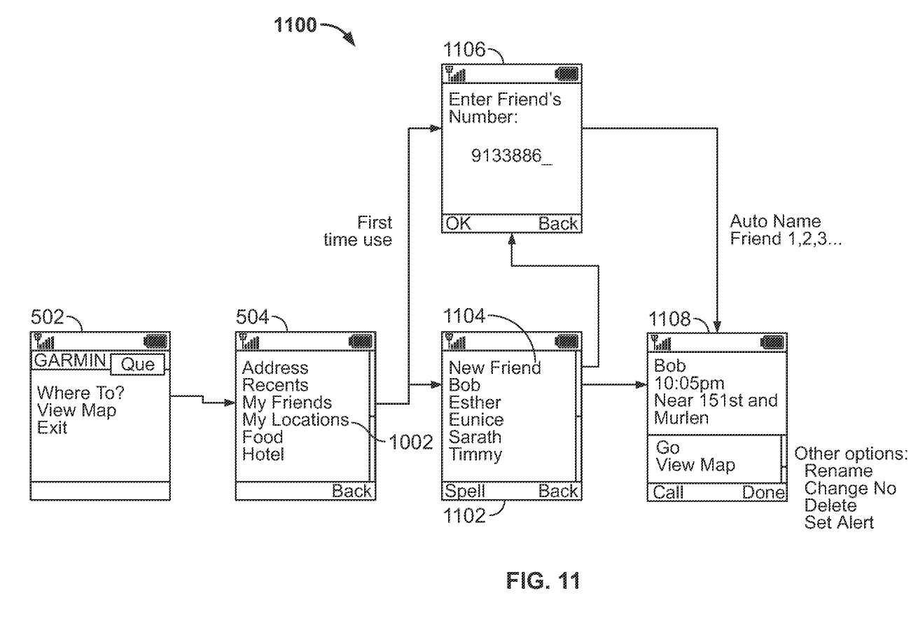

FIG. 11 illustrates a menu hierarchy 1100 offered in connection with performing a FIND FRIEND operation. Flow passes from the main menu 502 to a category menu 504, from which a MY FRIENDS option is selected. When the user's account already includes a list of friends, flow passes to page 1102 which presents the names of the friends stored in the MY FRIENDS category for the individual user. Page 1102 includes a NEW FRIEND option 1104 that may be selected when the user desires to add another individual to the list. At page 504, when the MY FRIENDS option is selected for the first, flow passes to page 1106. At page 1106, the user enters the appropriate information about the individual, such as telephone number, name, address and the like. When the NEW FRIEND option 1104 is selected from page 1102, flow also passes to page 1106 for the entry of a new individual. Next, flow passes to page 1108 from either of pages 1102 and 1106.

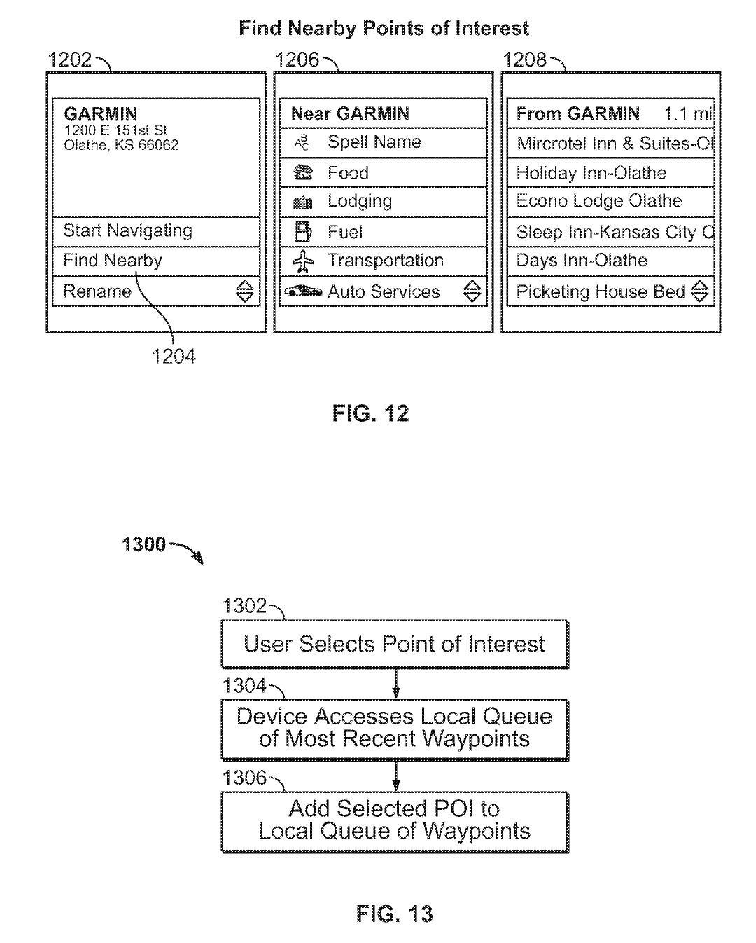

FIG. 12 illustrates a series of pages that may be presented in connection with finding near-by points of interest. Beginning at page 1202, the user enters a particular point of interest. Alternatively, page 1202 may be achieved through various of the above described processing sequences. Once a particular address is identified, such as displayed in page 1202, the user may select a FIND NEARBY option 1204, from which flow passes to page 1206 listing various categories of points of interests near the source location. Alternatively, page 1208 may be presented displaying various points of interests (such as within a single category, e.g., lodging) that are within a select distance of the source location.

FIG. 13 illustrates a flow chart of a processing sequence carried out by the processor 436 of the device 140 or 200 when a user selects a point of interest. When the user selects a point of interest at 1302, the device at 1304 accesses a local queue of the most recently stored waypoints. The queue is retained within either cache or the memory 442. At 1306, the processor 436 adds the selected points of interest to the queue of most recently selected waypoints. The queue may represent a FIFO buffer such that as new points of interest are added to the waypoint list, the oldest point of interest is written over or erased from the queue. For example, the queue may retain the ten most recently accessed waypoints. Optionally, the processor 436 may manage the waypoint queue in a more sophisticated manner. For example, the processor 436 may not duplicate points of interest in the queue. If out of the last ten waypoints, the user selects the same waypoint twice, the processor 436 may recognize the duplication in selected waypoints and not store the duplicate waypoint on the queue. Instead, at 1304, when the device accesses the local queue of most recent waypoints, the device would also compare newly selected point of interest with the existing waypoints in the queue. Processing would only move to 1306, at which the new selected POI was added to the queue, when the device determined at 1304 that the queue already did not include the selected POI.

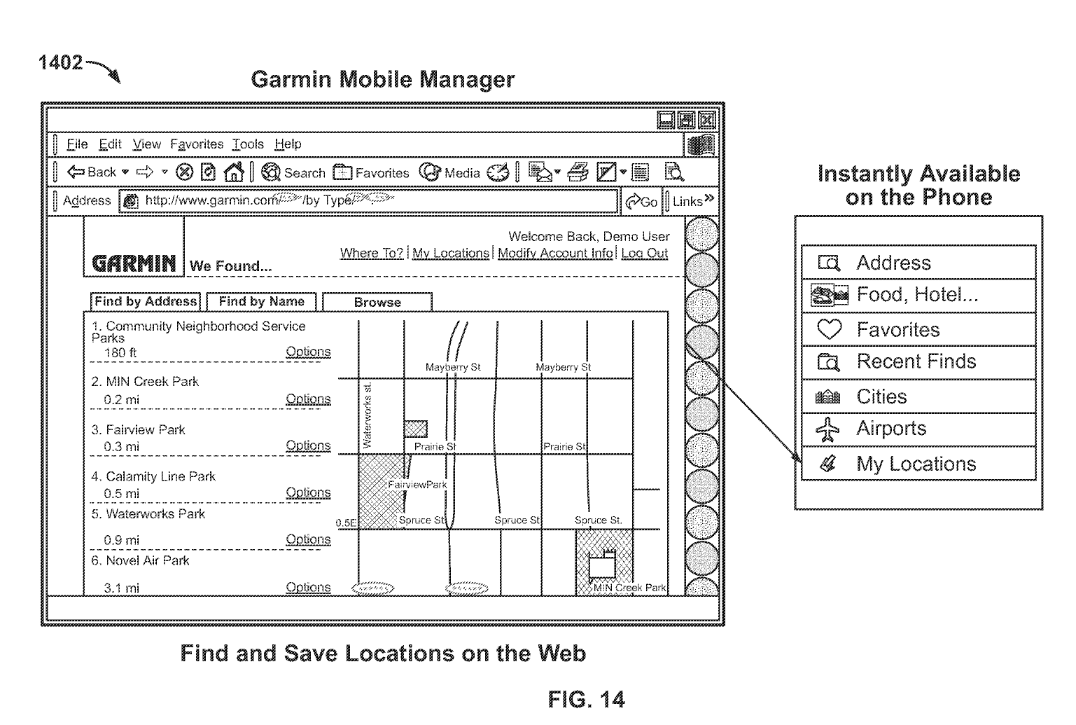

FIG. 14 illustrates a mobile manager function that may be presented, such as at a user's home PC 137 (FIG. 2). The user may access, via the home PC 137, a GPS server 133 and/or third party account manager 135 to add, delete and otherwise modify the user's individual waypoints or points of interest. In FIG. 14, a screen shot 1402 is illustrated that may be presented to the user, such as by logging on to a website maintained by GPS server 133 and/or third party account manager 135. From the home PC 137, the user may perform searches based on particular addresses or based on names. When a point of interest is identified, the user may add the location to the user's individual account of points of interest through the home PC 137. Once the new address is added to the individual user's points of interest, the POI is immediately available over the wireless device 140 for subsequent use by the user. In addition, by using the website, users may import or export location information to or from users' account. For example, users may import a database of contact information along with their respective locations, and in turn use the wireless device to access them. Or, users may use their wireless device to save locations to their web account, and in turn export those locations for others to access.

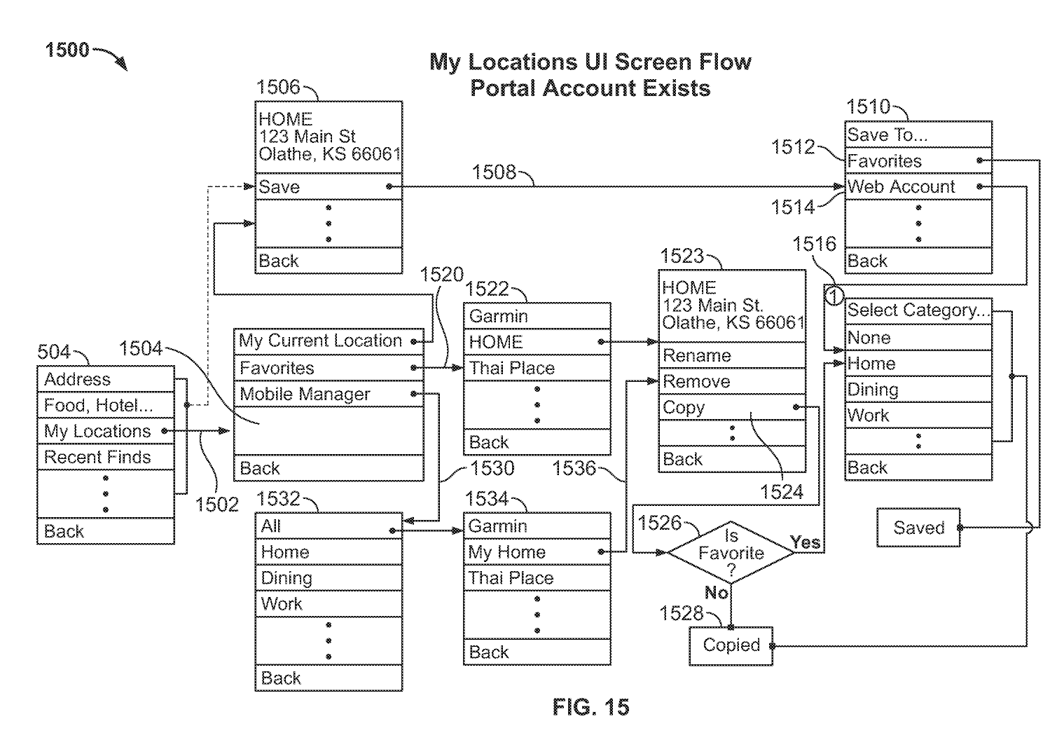

FIG. 15 illustrates a flow sequence or menu hierarchy 1500 associated with managing an individual user's waypoints or MY LOCATIONS. Beginning at the category menu 504, when the MY LOCATIONS option 1002 is selected flow passes along 1502 to a page 1504 presenting the following options, MY CURRENT LOCATIONS, FAVORITES AND MOBILE MANAGER. When the user desires to see the current location, an address screen 1506 is presented from which the user may save the current location (see flow path 1508). When the user desires to save the current location, a page 1510 is presented offering the user the option of saving the current location to the favorites 1512 or a web account 1514. When the current location is to be saved to a web account, flow passes along line 1516, and page 1518 is presented to permit the user to save the current location within a select category (e.g., none, home, dining, work, etc.).

Returning to page 1514, when the user selects the favorites option, flow passes along line 1520, after which a list 1522 of favorite saved locations is presented. When a user selects a location from the favorites, such as home, a corresponding address is presented (see page 1522). The user is also presented with options at page 1522 to rename, remove and copy the location. When the user selects the copy option 1524, a decision is made at 1526 as to whether the location is already saved in the favorites. If not, the location is saved to the favorites at 1528. If the location is already saved in the favorites, flow passes to page 1518 at which the user is presented with a list of categories in which to save the address.

Returning to page 1504, when the mobile manager is selected, flow passes along path 1530 to enable the user to manage (e.g., add, delete, copy, etc.) existing favorites. Page 1532 is presented with a list of categories (e.g., all, home, dining, work, etc.), from which the user may select a sub-category to manage. In the example of FIG. 15, all of the categories are selected and thus at page 1534, a complete listing of all of the user's favorites is presented. When the user selects a particular favorite, such as the user's home, flow passes along line 1536 to page 1522. At page 1522, the user is again given the options of renaming, removing, copying and otherwise modifying the selected location or point of interest. The screen flow illustrated in FIG. 15 is presented when a portal account exists for the user on one of the GPS server 133 and third party account manager 135.

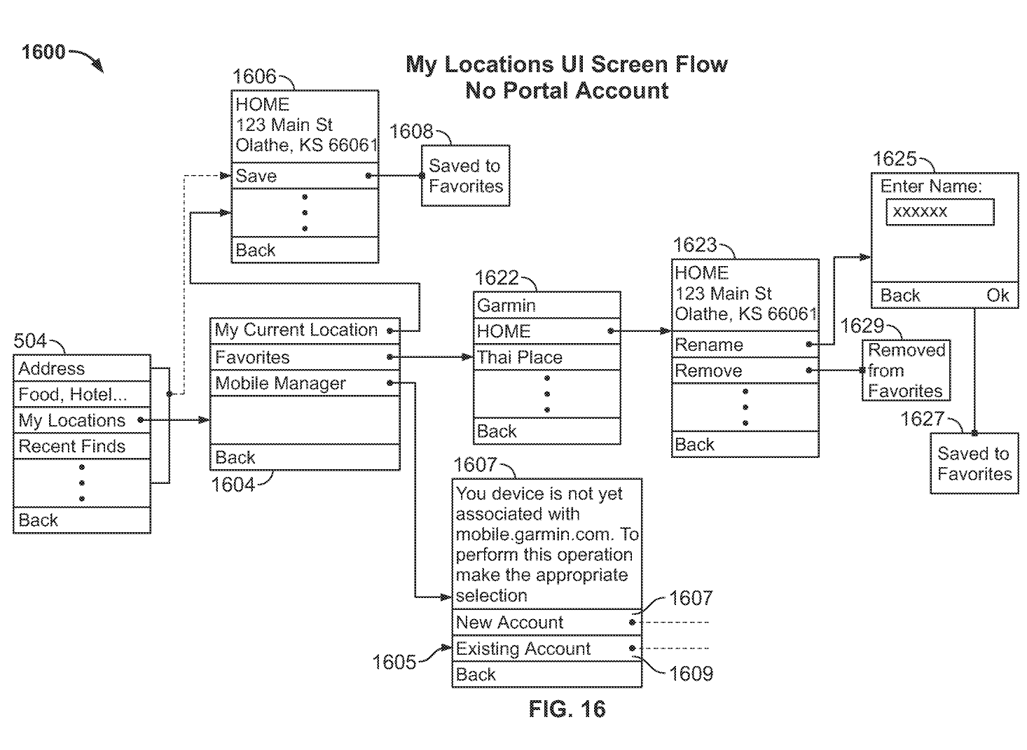

FIG. 16 illustrates an alternative screen flow 1600 that may be presented when no portal account exists. At the menu address 504, when an individual address is selected, an address screen 1606 is shown which offers the user various options, including the option to save the address. When the user desires to save the address, it is saved to the user's favorites directly at 1608. From the category menu 1504, when the MY LOCATIONS options is selected, the user is again presented with a screen 1604 having MY CURRENT LOCATION option, FAVORITES option, and MOBILE MANAGER option. When the FAVORITE option is selected, a list of favorites is presented at screen 1622. When one option from the favorites screen 1622 is selected, the corresponding address is presented at page 1623 and the user is afforded the ability to rename, remove and otherwise modify the address. When the RENAME option is selected, a text entry screen 1625 is presented in which the user may enter a new name for the address. After the new name is entered, the address is saved to the favorites at 1627. At page 1623, when the user selects the REMOVE option, flow passes to 1629 where the address is removed from the favorites.

Returning to page 1604, when the mobile manager is selected, an account manager screen 1605 is presented indicating that the device is not yet associated with the GPS server 133 and/or a third party account manager 135. The user is then presented with the option of opening a new account at option 1607 or logging in to an existing account at 1609. The new or existing account is then created based upon follow-up questions and data entry by the user at the device.

In accordance with the above illustrated screen flow and hardware and software, the user is afforded the options of storing desired locations or waypoints locally on the device in the local memory 442 within a local favorites memory section. Alternatively, the location or waypoints may be stored remotely in a user account stored on a dedicated navigation server, such as server 133. As a further option, the user may establish an account with a third party account manager 135 (e.g., YAHOO, AOL, MSN, etc.) and store the locations or waypoints on the account maintained by the third party account manager 135. The stored locations or waypoints on a server are placed in user defined categories (such as business, personal, home, etc.). The categories are displayed in various menus and screens on the phone and are reproduced at the website of the third party maintaining the account and/or the GPS server website.

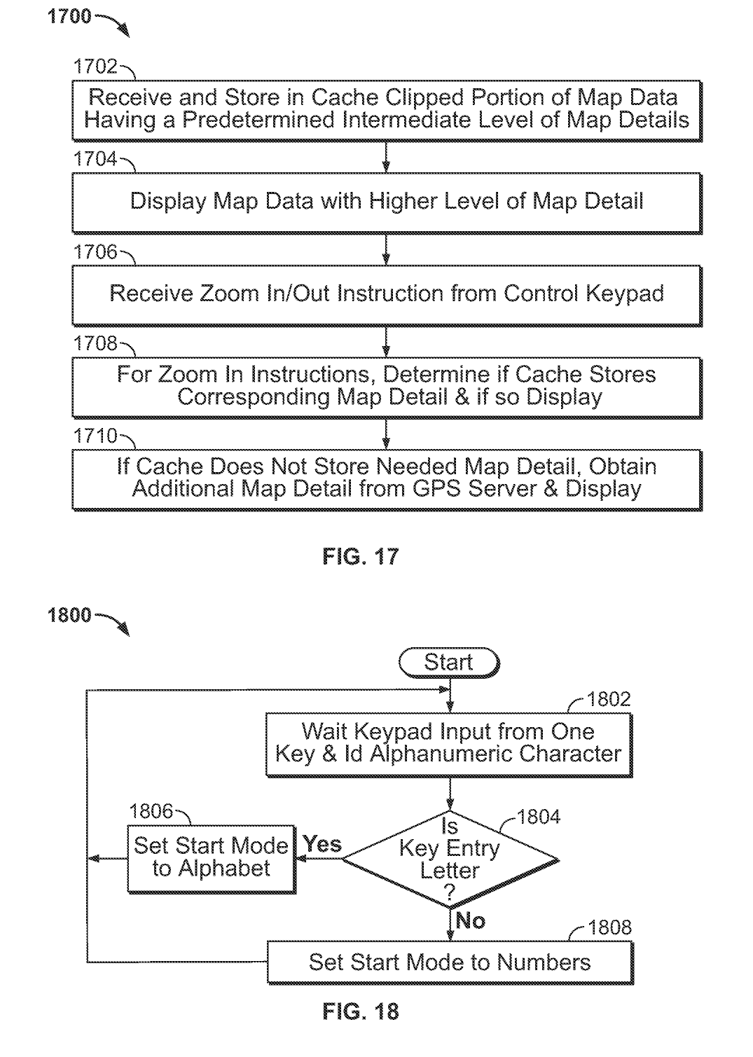

FIG. 17 illustrates an exemplary flowchart 1700 for a process carried out by the device 140 or 200 in connection with managing data storage within cache on the device while displaying mapping data. Beginning at 1702, the device receives navigation information that includes a clipped portion of the cartographic map (e.g. local map data). The local map data includes roadway network information. The roadway network information stored in the original cartographic database at the GPS server 133 includes a significant amount of low level detail for the features of the roadway network, such as node to node information, route information, intersection information, traffic pattern information, route classifications, points of interest, and the like. The local map data for a region of interest may include, at the lower level(s), more information than may be stored at one time in the cache of the device due to memory constraints. Thus, when the local map data is transmitted to the device, only a portion of the local map data may be stored in the cache, namely the information associated with intermediate and high level features of the roadway network. Examples of intermediate and high level features may include node information associated with interstate and major highways, as well as intersections between interstates and major highways.

At 1702, the device stores, in cache, map data having a predetermined intermediate level of map detail. The predetermined intermediate level is defined based on the capacity of the cache. Thus, a device having more cache memory may store lower level map details, while a device having less cache memory may only be able to store higher-level map details. At 1704, the device accesses an initial level of map detail from the map data and displays the map data with the selected initial (higher) level of map detail. The user may desire to view more or less map detail by zooming inward and outward, respectively. At 1706, the device receives a zoom-in or zoom-out instruction from the control keypad. For zoom-in instructions, at 1708, the device determines whether the cache stores the corresponding level of map detail. If the cache stores a level of map detail sufficient to display a map at the zoom level requested by the user, the device presents, on the display, the map data from the cache.

If the device determines that the cache does not store a sufficient lower level of map detail, processing moves to step 1710. At step 1710, the device transmits a request for navigation information to the GPS server 133. The request for navigation information includes a request for more detailed information regarding the region of interest. Upon receiving the more detailed information from the GPS server 133, the device then displays the corresponding detailed map information.

FIG. 18 illustrates a processing sequence 1800 carried out by the processor 436 when a user is entering alphanumeric characters through the keypad 115. The keypad 115 is configured similar to a keypad found on a cell phone, including keys, each of which is associated with one number and a series of letters. The sequence of FIG. 18 operates based on the premise that when a user enters a number, the next entry by the user will also, more than likely, be another number. Conversely, when a user enters a letter, the next entry by the user will also, more than likely, be another letter.

Beginning at 1802, the device waits for the user to enter a keypad input from one key. For example, the user may press one key three consecutive times to sequence through the potential options associated with the key. Once the user reaches the desired character, at 1802, the key entry is identified as either a letter or number or symbol. Once the key entry is identified at 1802, flow passes to 1804, at which the processor 436 determines whether the key entry represented a letter. When the key entry is a letter, flow moves to 1806, at which the processor 436 sets the “start mode” to alphabetic characters. When the start mode is set to alphabetic characters and the user next press is a key, the first character presented to the user is an alphabetic letter assigned to such key (not a number). Thus, once a user starts to enter a word, after entering the first letter, the device will enter an “alphabetic start mode” for each subsequent letter such that the user need not first sequence through the numerals assigned to each key before reaching the letters.

At 1804, if the key entry is not a letter, flow passes to 1808, at which the “start mode” is set to numbers or digits. Thus, when a user starts to enter a telephone number or address, after entering the first number, the device will enter a “digit start mode” for each subsequent number. As a further option, the start mode may be set based on the context of the data entry or page that is presently being displayed to the user. Alternatively, the start mode may be selected based upon a previously entered word or number sequence. For example, if the user has already entered “143nd”, then the device may assume that the user will next type in some type of phrase that is alphabetic, such as “place” or “street”.

While the invention has been described in terms of various specific embodiments, those skilled in the art will recognize that the invention can be practiced with modification within the spirit and scope of the claims.

What is claimed is:

1. A mobile device comprising:
a display;
a satellite navigation receiver operable to receive satellite navigation signals from one or more satellites to determine a current geographic location of the mobile device;
a memory including a friend database operable to store data corresponding to a plurality of friend names, associated friend locations, and associated location update times;
a wireless communication receiver operable to bi-directionally communicate with a wireless network to receive the friend locations for storage within the friend database; and
a processor coupled with the display, the satellite navigation receiver, the wireless communication receiver; and the memory, the processor operable to:
access the friend database,
present a listing of at least one of the friend names stored within the friend database, and
in response to selection of one of the listed friend names by a user, present on the display a friend status page indicating the name of the selected friend, a street address corresponding to the location associated with the selected friend, and the location update time associated with the selected friend.

2. The mobile device of claim 1, wherein the memory further includes map information and the processor is operable to present on the display a map including the location associated with the selected friend.

3. The mobile device of claim 2, wherein the processor is further operable to retrieve the map information through the wireless network using the wireless communication receiver.

4. The mobile device of claim 2, wherein the processor is further operable to provide an indication of a route to the location associated with the selected friend on the displayed map.

5. The mobile device of claim 4, wherein the processor is further operable to retrieve the route through the wireless network using the wireless communication receiver.

6. The mobile device of claim 1, wherein the processor is further operable to initiate a voice communication with the selected friend using the wireless communication receiver.

7. The mobile device of claim 1, wherein the wireless communication receiver is operable to communicate with a cellular network.

8. The mobile device of claim 1, further including a control operable to be functioned by the user to select one of the friends from the listing.

9. The mobile device of claim 8, wherein the control is further operable to be functioned by the user to store information corresponding to one or more friends in the friend database.

10. A mobile device comprising:
a display;
a satellite navigation receiver operable to receive satellite navigation signals from one or more satellites to determine a current geographic location of the mobile device;
a memory including map information and a friend database, the friend database operable to store data corresponding to a plurality of friend names, associated friend locations, and associated location update times;
a wireless communication receiver operable to bi-directionally communicate with a wireless network to receive the associated friend locations for storage within the friend database; and
a processor coupled with the display, the satellite navigation receiver, the wireless communication receiver; and the memory, the processor operable to:
access the friend database,
present a listing of at least one of the friend names stored within the friend database, and
in response to selection of one of the listed friend names by a user, present on the display a friend status page including:
the name of the selected friend,
a street address corresponding to the location associated with the selected friend,
the location update time associated with the selected friend,
a view map option operable to be selected by the user to cause the processor to present on the display a map including the location associated with the selected friend,
a routing option operable to be selected by the user to cause the processor to provide an indication of a route to the location associated with the selected friend on a displayed map, and
a call option operable to be selected by the user to cause the processor to initiate a voice communication with the selected friend using the wireless communication receiver.

11. The mobile device of claim 10, wherein the processor is further operable to retrieve the map information through the wireless network using the wireless communication receiver.

12. The mobile device of claim 10, wherein the processor is further operable to retrieve the route through the wireless network using the wireless communication receiver.

13. The mobile device of claim 10, wherein the wireless communication receiver is operable to communicate with a cellular network.

14. The mobile device of claim 10, further including a control operable to be functioned by the user to select one of the friends from the listing.

15. The mobile device of claim 14, wherein the control is further operable to be functioned by the user to store information corresponding to one or more friends in the friend database.
